(19) United States
(12) Patent Application Publication
(10) Pub. No.: US 2003/0070821 A1
(43) Pub. Date: Apr. 17, 2003

(54) Slide hammer stake driver

(76) Inventor: Kevin McPhillips, Winters, CA (US)

Correspondence Address: FLIESLER DUBB MEYER & LOVEJOY, LLP, FOUR EMBARCADERO CENTER, SUITE 400, SAN FRANCISCO, CA, 94111, US

(21) Appl. No.: 09/975,869

(22) Filed: Oct. 12, 2001

(51) Int. Cl. B25D 9/00

(52) U.S. Cl. 173/90

(57) ABSTRACT

A slide hammer for installing stakes into the ground is provided. The slide hammer comprises a shaft with a pointed first end, a cup located on the second end, an impact ring located between the ends of the shaft, and a slideable weight located between the cup and the impact ring. The slideable weight has a gripping surface for the user to hold, and striking surfaces to forcibly contact the cup and the impact ring as the user reciprocally moves the slideable weight. The slide hammer allows the user to pre-make a hole in the ground prior to stake installation. The user is then able to install the stake into the pre-made hole using a reduced amount of force required to drive the stake into the ground.

### TECHNICAL FIELD

The present invention relates to an apparatus and method for installing stakes into the ground and, in particular, a slide hammer for installing stakes into the ground wherein the slide hammer prevents damage to the stakes while installing the stakes.

### BACKGROUND

It is well known in the industry to use hammers for driving stakes in to the ground, however, these hammers present a number of disadvantages. One disadvantage of using a hammer is that the hammer and stake must be firmly gripped. Because contact is made between the hammer and the stake while the user is firmly gripping the hammer and stake, much of the force of the impact is transmitted back through the user's hands and arms. This force transmitted back through the hands and arms causes pain and discomfort which can lead to permanent physical damage. Another disadvantage of using a hammer is that the hammer has to be swung with great force such that the hammer itself is dangerous to the user because the user often times strikes himself when missing the stake with the hammer, consequently injuring the user. Another disadvantage of using a hammer is that the hammer damages and distorts the stake, thus weakening the stake or preventing the stake from multiple reuse. In order to reduce the disadvantages of a hammer, the industry has adopted alternative hammering means such as the slide hammer.

The slide hammer is well known in the industry for driving objects into the ground. For example, in U.S. Pat. No. 3,651,873 to Uebel et al., an apparatus having a slideable hammer for driving objects such as poles, planks, boardings, and pipes into the ground is disclosed. In another example, U.S. Pat. No. 4,261,424 to Gonterman et al., an apparatus having a reciprocating striking member for driving stakes into the ground is disclosed. Although these cited references reduce the physical damage a user may suffer when driving stakes into the ground, these references do not prevent damage to the stakes during their installation using these slide hammers.

What is needed, therefore, is a device for installing stakes into the ground such that the device both minimizes the physical damage a user may suffer when installing stakes and prevents the stake from being damaged during installation.

### SUMMARY

An object of the invention is to provide a device for installing stakes into the ground.

Another object of the invention is to provide a device that prevents the stakes from being damaged during installation.

A further object of the invention is to provide a method for installing stakes into the ground such that the method prevents the stakes from being damaged during installation.

The present invention meets the above-mentioned objects by providing a novel slide hammer that safely drives stakes into the ground with minimal damage to the stakes. The slide hammer comprises a shaft with a pointed first end, a cup located on the second end, an impact ring located between the ends of the shaft, and a slideable weight located between the cup and the impact ring. The pointed end serves to create a hole in the ground, this hole being a starter hole for the stake. The cup serves both as a striking surface and as a tool to hold the stake in place as the stake is being installed using the slide hammer. The impact ring is used as a striking surface as the pointed end of the slide hammer is driven into the ground. The slideable weight comprises a pair of striking surfaces that forcibly contact the cup and/or the impact ring during use.

The user drives the pointed end of the slide hammer into the ground by reciprocally striking the impact ring with the slideable weight until a desired depth is obtained. The user then removes the pointed end of the slide hammer by reciprocally striking the cup with the slideable weight. Removal of the pointed end results in a hole about the same diameter as the diameter of the shaft of the pointed end of the slide hammer. Once the slide hammer is removed, the user places the stake into the hole, places the cup over the stake, and reciprocally moves the slideable weight to forcibly contact the cup, thus driving the stake into the pre-made hole.

### BRIEF DESCRIPTION OF THE DRAWINGS

FIG. 1 is a perspective view of the slide hammer comprising the preferred embodiment of the applicant's invention.

### DETAILED DESCRIPTION OF THE PREFERRED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended and such alterations and further modifications in the illustrated devices, and such further applications of the principles of the invention as illustrated therein being contemplated as would normally occur to one skilled in the art to which the invention relates.

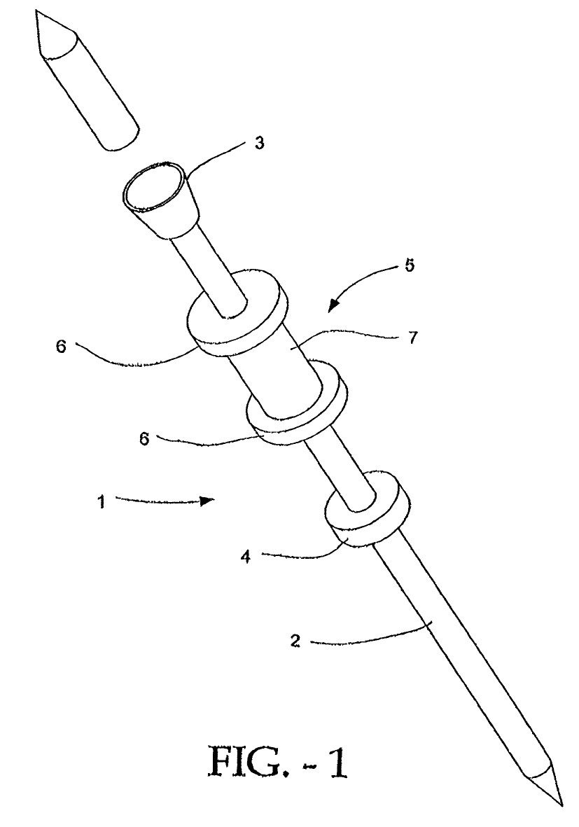

Referring to FIG. 1, therein is depicted a preferred embodiment of the applicant's slide hammer 1. The slide hammer 1 comprises a shaft 2, a cup 3 solidly attached to one end of the shaft 2, an impact ring 4 solidly attached between the ends of the shaft 2, and a slideable weight 5 located between the cup 3 and the impact ring 4.

In a preferred embodiment, the slide hammer 1 comprises a slideable weight 5 having a first and second striking surfaces 6 and a gripping surface 7 therebetween. The striking surfaces 6 may define a plurality of different shapes including, but not limited to, rectangular, square, triangular, and circular. The striking surfaces 6 are substantially flat on the impact sides to ensure a flat-like impact upon contact, however, the striking surfaces 6 need not be substantially flat on the non-impact sides. The gripping surface 7 located between the striking surfaces 6 may define a plurality of different shapes including, but not limited to, rectangular, square, triangular, and circular, to conform to the grip of the user. The striking surfaces 6 may be larger than the gripping surface to prevent the user from pinching his fingers or hand between the striking surface 6 and cup 3, or between the striking surface 6 and impact ring 4.

In a preferred embodiment, the slideable weight 5 may be concentrically positioned around the shaft 2 between the cup 3 and impact ring 4, such that the slideable weight 5 may reciprocally slide over the shaft 2 without substantial friction that would impair the striking effectiveness. The slideable weight 5 may further include bearings to reduce friction as the user reciprocally moves the slideable weight 5 over the shaft 2.

In a preferred embodiment, the bottom of cup 3 is solidly attached to one end of the shaft 2 such that the open end of the cup 3 faces outwardly away from the shaft 2. The cup 3 is attached through welding or other means that prevent the cup 3 from being dislodged upon impact from the slideable weight 5. The bottom of the cup 3 is substantially flat to ensure a flat-like impact upon contact with the striking surface 6 of the slideable weight 5. The cup 3 may define various different shapes in order to hold stakes securely by providing for a structure that holds the stake, by encompassing the top end of the stake, such that the side walls of the cup 3 substantially cover a defined length of the top end of the stake. The cup 3 ensures that every blow the user exerts on the stake is optimally used because each blow results in contact with the stake, as opposed to a hammer where the user may miss the stake and injure himself. Thus, the cup prevents the user from being injured by preventing misses while delivering blows to the stake.

As noted, the cup 3 is not limited to a specific configuration, however, in a preferred embodiment the cup 3 maybe circumferentially larger on the open end of the cup 3 than the bottom of the cup, and may linearly and concentrically decrease in diameter moving from the open end of the cup 3 towards the bottom of the cup 3 such that this shape of the cup allows stakes of different sizes to be held securely.

In a preferred embodiment, the impact ring 4 is concentrically and solidly attached to the shaft 2, through welding or other sufficient means, such that the impact of the slideable weight 5 does not dislodge the impact ring 4 from the shaft 2. The ring 4 has a substantially flat surface on the impact side to ensure a flat-like impact upon contact with the slideable weight 5. The impact ring 4 may define a plurality of shapes including, but not limited to, rectangular, square, triangular, and circular.

In a preferred embodiment, the slide hammer 1 is made of a hard material such as steel. The slide hammer 1 is about forty-two (42) inches in length from end to end. The slide hammer 1 has a slideable weight 5 of about seven (7) inches in length. The impact ring 4 is about twenty-four (24) inches from one end of the slide hammer 1. The shaft 2 of the slide hammer 1 is about 0.625 inches in diameter.

In a preferred method for installing stakes into the ground, the method comprises reciprocally moving the slideable weight 5 such that the striking surface 6 of the slideable weight 5 contacts the impact ring 4 to drive the pointed end of the shaft 2 into the ground, reciprocally moving the slideable weight 5 such that the striking surface 6 of the slideable weight 5 contacts the cup 3 to remove the pointed end of the shaft 2 from the ground thereby producing a hole into the ground, placing a stake into the hole, placing the cup 3 over the end of the stake, reciprocally moving the slideable weight 5 such that the striking surface 6 contacts the cup 3 to drive the stake into the ground.

In a preferred method for installing stakes into the ground, the slide hammer 1 and in particularly cup 3 allows a user to drive the stake into the ground without the user having to grip the stake.

In a preferred method for installing stakes into the ground, the method minimizes stake distortion because the slide hammer 1 allows the user to pre-make a hole in the ground prior to stake installation. The user is then able to install the stake into the pre-made hole using a reduced amount of force required to drive the stake into the ground. Thus, less force is required to drive in the stake into the ground resulting in minimal damage to the stake.

It will be understood that no limitation of the scope of the invention is thereby intended, such alterations and further modifications in the illustrated devices, and such further applications of the principles of the invention as illustrated therein being contemplated as would normally occur to one skilled in the art to which the invention relates.

What is claimed is:

1. A slide hammer comprising:
a shaft having a first end and a second end, said first end of said shaft defining the shape of a pointed end; a cup attached to said second end of said shaft such that the open end of said cup faces outward from said second end of said shaft;
an impact ring solidly attached to said shaft between said first end and said second end of said shaft; and
a slideable weight located between said cup and said impact ring.

2. The slide hammer of claim 1, wherein said slideable weight comprises a first and second striking surfaces and a gripping surface therebetween.

3. The slide hammer of claim 1, wherein said slideable weight defines a barbell like structure comprising a first end and a second end with a cylindrical centerpiece therebetween, said first end and said second end defining ring like structures, said first end and said second end being radially larger than said cylindrical centerpiece.

4. The slide hammer of claim 1, wherein the slide hammer is about forty-two (42) inches long.

5. The slide hammer of claim 1, wherein said impact ring is located about twenty-four (24) inches from said first end of said shaft.

6. The slide hammer of claim 1, wherein said slideable weight is about seven (7) inches long.

7. The slide hammer of claim 1, wherein said shaft is about 0.625 inches in diameter.

8. The slide hammer of claim 1, wherein the slide hammer is made of a hard metal such as steel.

9. A method for implanting stakes into the ground, the method comprising the steps of:
moving a slideable weight back and forth such that a striking surface of the slideable weight contacts an impact ring to project a pointed end of the slide hammer into the ground unit a desired depth is obtained;
moving the slideable weight back and forth such that the striking surface of the slideable weight contacts a cup to remove the pointed end of the slide hammer from the ground until the pointed end is completely removed, thus creating a hole in the ground;
placing a stake into the hole;
placing the cup of the slide hammer over the stake; and
moving the slideable weight back and forth such that each the striking surface of the slideable weight contacts the cup to project the stake into the ground until a desired depth of the stake is obtained.

10. The method of claim 9, wherein the moving steps comprise reciprocally moving the slideable weight.
